(19) United States
(12) Patent Application Publication
(10) Pub. No.: US 2016/0249294 A1
(43) Pub. Date: Aug. 25, 2016

(54) METHOD OF CONTROLLING TERMINAL AND TERMINAL EMPLOYING THE METHOD

(71) Applicant: Samsung Electronics Co., Ltd., Gyeonggi-do (KR)

(72) Inventors: Young-sik LEE, Gyeonggi-do (KR); Chun-ho Lee, Gyeonggi-do (KR); Hyun-woo Lim, Seoul (KR)

(73) Assignee: Samsung Electronics Co., Ltd.

(21) Appl. No.: 15/053,641

(22) Filed: Feb. 25, 2016

(30) Foreign Application Priority Data
Feb. 25, 2015 (KR) 10-2015-0026752

(51) Int. Cl. H04W 52/02; H04W 52/28; H04W 4/04

(52) U.S. Cl. CPC H04W 52/0251; H04W 4/046; H04W 52/283

(57) ABSTRACT

Disclosed is a method of controlling a terminal. Context information related to a location of the terminal is acquired, and the location of the terminal is determined by comparing acquired context information and patterns information representing a target location previously set. At least one of transmission power and a scan period for communication between the terminal and another terminal is determined according to characteristics of the determined location.

### PRIORITY

This application claims priority under 35 U.S.C. 119 to Korean Patent Application No. 10-2015-0026752, filed on Feb. 25, 2015 in the Korean Intellectual Property Office, the contents of which are incorporated herein by reference.

### BACKGROUND OF THE DISCLOSURE

1. Field of the Disclosure

The present disclosure relates generally to a method of controlling a terminal, and more particularly, to method of controlling a terminal whereby power efficiency of the terminal may be enhanced.

2. Description of the Related Art

As the market for the Internet of Things (IoT) continues to grow, research on methods for bidirectional communication between a plurality of terminals has been actively conducted. In particular, there has been an attempt to perform various methods for communication between devices with no conventional Internet access capabilities.

Internet connection for devices not having Internet access capabilities requires the installation of modems, which is costly and time consuming. Accordingly, extensive research has been conducted on the use of tethering instead of modems. Tethering allows sharing an Internet connection of a tethered terminal having Internet connection capability and enables devices to access the Internet through the tethered terminal.

However, when one or more additional terminals are connected to the Internet by using the tethering feature of a terminal, power consumption of the terminal offered for tethering may suddenly increase.

As such, there is a need in the art for a method of controlling power consumption when the tethering feature is implemented.

### SUMMARY OF THE DISCLOSURE

The present disclosure has been made to address the above-mentioned problems and disadvantages, and to provide at least the advantages described below. Accordingly, an aspect of the present disclosure is to provide a method of controlling a terminal, whereby power efficiency of the terminal may be enhanced by predicting a condition of the terminal from context information collected in the terminal and adaptively changing resources used for communication according to the predicted condition.

According to an aspect of the present disclosure, a method of controlling a terminal includes acquiring context information related to a location of the terminal, determining the location of the terminal by comparing acquired context information and patterns information related to a target location previously set, and determining at least one of transmission power and a scan period for communication between the terminal and another terminal according to characteristics of the determined location.

According to another aspect of the present disclosure, a terminal includes a context information acquirer that acquires context information related to a location of the terminal, a position determiner that determines the location of the terminal by comparing acquired context information and patterns information related to a target location previously set, and a controller that determines at least one of transmission power and a scan period for communication between the terminal and another terminal according to characteristics of the determined location.

According to another aspect of the present disclosure, a non-transitory computer-readable storage medium is disclosed having stored therein program instructions which, when executed by a computer, perform the method of controlling a terminal, including acquiring context information related to a location of the terminal, determining the location of the terminal by comparing acquired context information and patterns information related to a target location previously set, and determining at least one of transmission power and a scan period for communication between the terminal and another terminal according to characteristics of the determined location.

### BRIEF DESCRIPTION OF THE DRAWINGS

The above and/or other aspects, features, and advantages of the present disclosure will become apparent and more readily appreciated from the following description of the embodiments, taken in conjunction with the accompanying drawings in which:

FIG. 1 illustrates a method of controlling a terminal in accordance with an embodiment of the present disclosure;

FIG. 2 is a flowchart of a method of controlling a terminal in accordance with an embodiment of the present disclosure;

FIG. 3 is a flowchart of a method used by a terminal to determine at least one of transmission power and a scan period according to characteristics of a terminal location determined based on information detected from surroundings of the terminal in accordance with an embodiment of the present disclosure;

FIG. 4 is a flowchart of a method used by a terminal to determine at least one of transmission power and a scan period according to characteristics of a terminal location determined based on history information of connections between the terminal and another device at a target location in accordance with an embodiment of the present disclosure;

FIG. 5 illustrates a method of determining at least one of transmission power and a scan period according to characteristics of terminal location determined based on the connection of a terminal and another device at a target location in accordance with an embodiment of the present disclosure;

FIGS. 6A and 6B illustrate a method of determining transmission power based on types of vehicles in accordance with an embodiment of the present disclosure;

FIGS. 7A and 7B illustrate a method of determining scan periods for other terminals according to characteristics of a location of a terminal in accordance with an embodiment of the present disclosure;

FIG. 8 is a flowchart of a method used by a terminal to acquire context information in a predetermined interval and update the information related to a location of the terminal in accordance with an embodiment of the present disclosure;

FIG. 9 is a flowchart of a method used by a terminal according to an embodiment to transmit information of at least one of transmission power and a scan period to another terminal at a target location when the terminal is located at the target location in accordance with an embodiment of the present disclosure;

FIG. 10 illustrates a method used by a terminal according to an embodiment to transmit information of at least one of transmission power and a scan period to another terminal at a target location when the terminal is located at the target location in accordance with an embodiment of the present disclosure; and

FIGS. 11 and 12 are block diagrams of a terminal according to an embodiment of the present disclosure.

### DETAILED DESCRIPTION OF EMBODIMENTS OF THE DISCLOSURE

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present disclosure. In describing the present disclosure below, a detailed description of related known configurations or functions incorporated herein will be omitted for the sake of clarity and conciseness.

It will be understood that when an element is referred to as being “connected to” another element, it can be “directly connected to” the other element or “electrically connected to” the other element. The terms “comprises” and/or “comprising” or “includes” and/or “including” or “contains” and/or “containing” when used in this specification, specify the presence of stated elements, but do not preclude the presence or addition of one or more other elements.

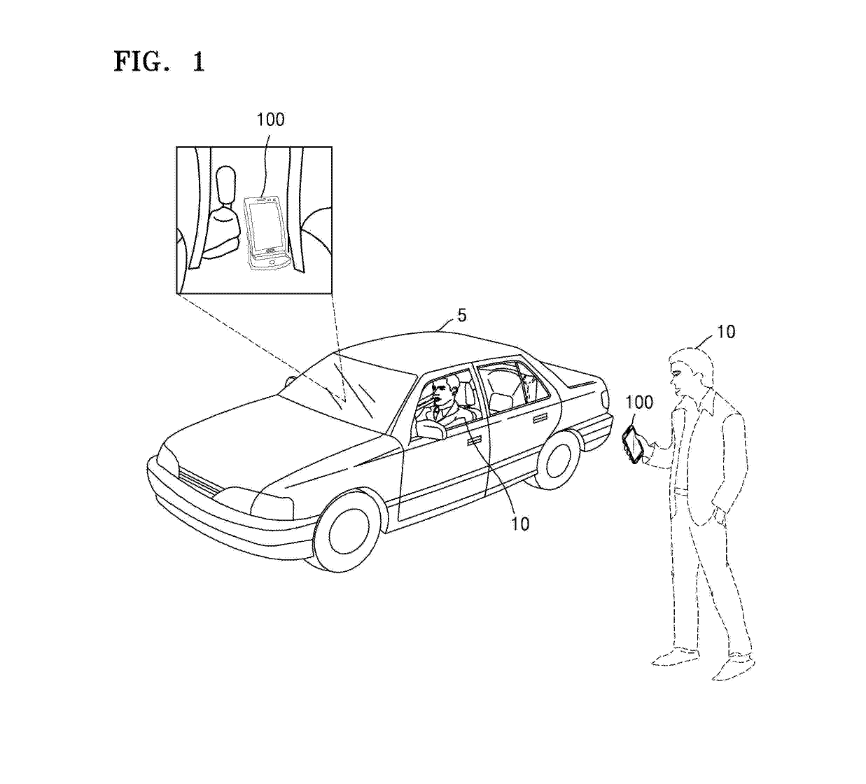

FIG. 1 illustrates a method of controlling a terminal 100 according to an embodiment of the present disclosure.

Referring to FIG. 1, the terminal 100 may be used for tethering so that the terminal 100 may operate as a wireless modem. The terminal 100 permits one or more information technology (IT) devices to be connected thereto via universal serial bus (USB), Bluetooth™, or WiFi connection. The IT devices connected to the terminal 100 may access the Internet via tethered wireless connection through the terminal 100. The IT devices include a smartphone, a notebook computer, a tablet personal computer (PC), a vehicle, and a wearable device in various embodiments, but are not limited thereto.

A vehicle 5 will be described in the specification as an example of IT devices that may be tethered to the terminal 100.

When the terminal 100 is offered for the tethering, the terminal 100 checks for the presence of connectable IT devices. For example, the terminal 100 transmits a beacon frame based on predetermined scan period and transmission power. The terminal 100 determines the connectable IT devices based on the presence of IT devices responding to the beacon frame. Hereinbelow, the IT devices that may be tethered to the terminal 100 are referred to as “another” terminals, “other” terminals, or “the other” terminals.

The terminal 100 determines at least one of the transmission power and the scan period for transmitting frames to search other terminals depending on the location of the terminal 100. For example, when the terminal 100 is located in the vehicle 5, the space inside the vehicle 4 may be limited. When the vehicle 5 is in motion, another terminal in the vehicle 5 moves with the terminal 100. Thus, the terminal in the vehicle 5 may use the wireless Internet without continuously performing scans for searching another access point (AP).

The terminal 100 controls the transmission power and the scan period for searching other terminals to be tethered, by using distinct characteristics of the vehicle inside. For example, the terminal 100 increases the scan period while lowering the transmission power if a current location is identified as being inside of a vehicle.

The terminal 100 acquires context information representing the location of the terminal 100. The context information includes acceleration information of the terminal 100, atmospheric pressure and sound information of surroundings, history information of the terminal 100 about connections with other terminals in a particular location. The terminal 100 compares acquired context information with patterns information representing target location set previously, and determines the location of the terminal 100. As the location of the terminal 100 is determined, the terminal 100 determines characteristics of the location of the terminal 100 based on characteristics of the target location stored previously in a database.

For example, as a user 10 moves in FIG. 1, the location of the terminal 100 changes from inside to outside of the vehicle 5. The terminal 100 determines at least one of the transmission power and the scan period for searching other terminals inside the vehicle 5 depending on characteristics of the vehicle 5.

The terminal 100 enhances power efficiency by determining at least one of the transmission power and the scan period for searching other terminals depending on characteristics of the location of the terminal 100.

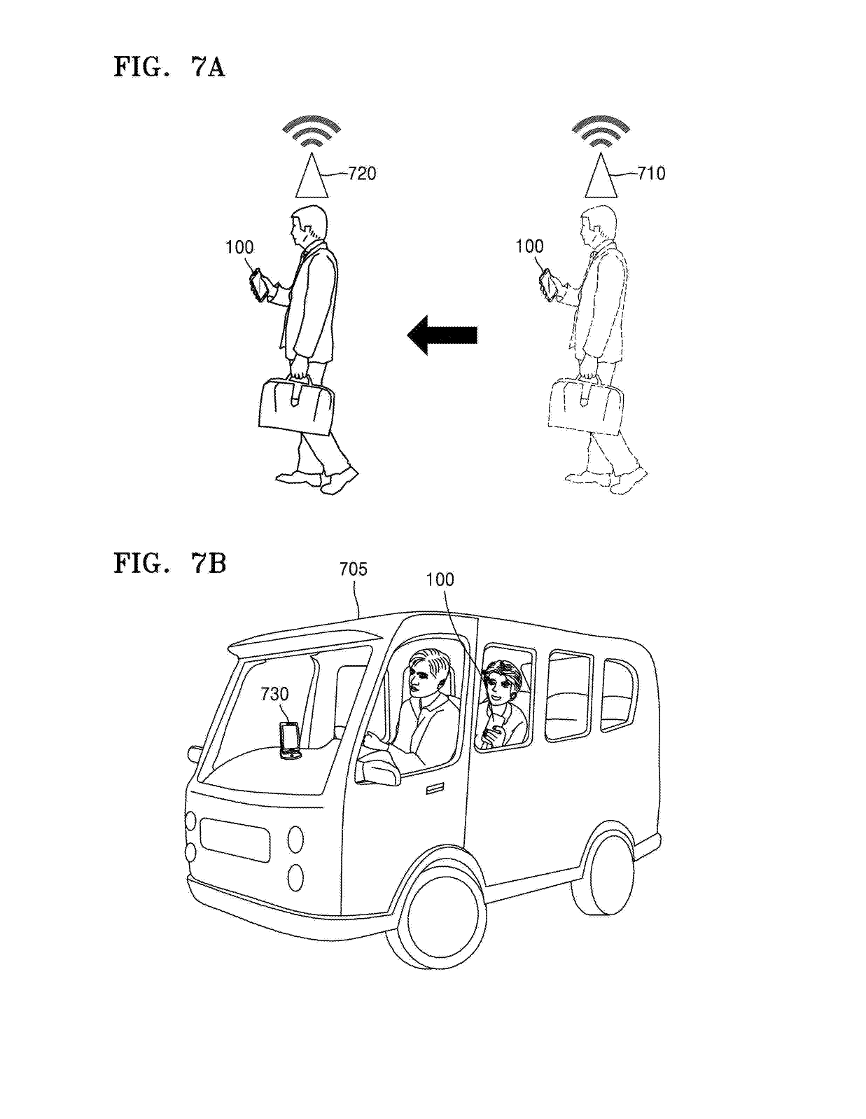

When the terminal 100 is provided with the tethering service by another terminal, the terminal 100 controls the transmission power for transmitting frames to the other terminal depending on the characteristics of the location of the terminal 100, which is described below in detail with reference to FIG. 7.

The terminals 100 include, but are not limited to a wearable device, a WiFi enabled device, a Bluetooth™ appcessory, a tablet PC, a smartphone, a WiFi router.

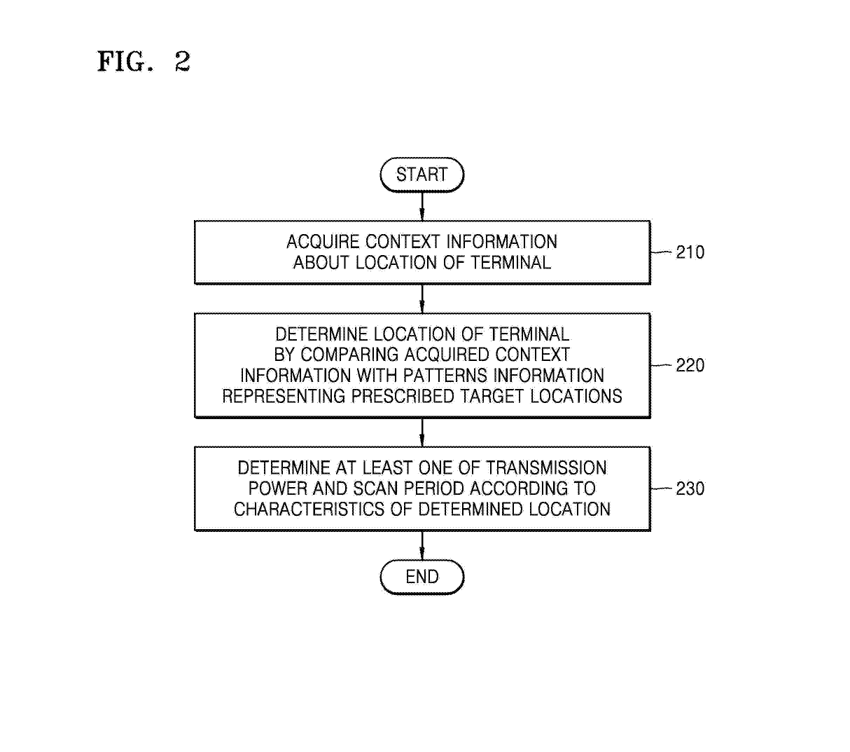

FIG. 2 is a flowchart explaining a method for controlling the terminal 100 in accordance with an embodiment of the present disclosure.

In step S210, the terminal 100 acquires context information representing the location of the terminal 100.

The context information includes acceleration information of the terminal 100, and atmospheric pressure and sound information of surroundings of the terminal 100. For example, when the terminal 100 is in motion as the movement of the user occupying the terminal 100, the terminal 100 acquires the acceleration information. The terminal 100 acquires the atmospheric pressure information by measuring atmospheric pressure of the surroundings that changes with the movement of the terminal 100. The terminal 100 acquires the sound information by detecting sound of the surroundings that change with the movement of the terminal 100.

According to another embodiment, the context information includes history information related to connections of the terminal 100 with another terminal present at a particular location. For example, the connection history information includes history information indicating that the terminal 100 has received power from a wireless charging device present at the particular location and history information indicating that the terminal 100 has received signals from a sensor device present at the particular location.

The examples of the context information are provided to explain the present disclosure, and the context information of the present disclosure is not limited thereto.

In step S220, the terminal 100 determines the location of the terminal 100 by comparing the acquired context information with patterns information representing the target location set previously. The patterns information may be generated based on the acceleration information, the atmospheric pressure information, the sound information, and the connection history information that may be acquired when the terminal is present at the target location.

For example, since the atmospheric pressure in the vehicle 5 may be different from the pressure outside the vehicle 5, the terminal 100 includes the atmospheric pressure in the vehicle 5 in the patterns information representing the inside of the vehicle 5. When the user 10 is riding in the vehicle 5, the terminal 100 determines the acceleration information of the terminal 100 as one of the patterns information representing the inside of the vehicle 5.

The terminal 100 determines sound information that is detected when the user 10 is riding in the vehicle 5 as one of the patterns information representing the inside of the vehicle 5. For example, the terminal 100 determines information of sounds that are generated when the user 10 opens and closes a door of the vehicle 5 as the patterns information representing the inside of the vehicle 5.

According to another example, the terminal 100 determines the history information indicating that the terminal 100 has been charged from a wireless charging device present at the vehicle 5 as the patterns information. The terminal 100 determines the history information indicating that the terminal 100 has transmitted or received control signals to or from an on-board diagnostics (OBD) device present at the vehicle 5 as the patterns information.

In step S230, the terminal 100 determines at least one of the transmission power and the scan period, for communications with another terminal, according to the characteristics of determined location.

The terminal 100 stores characteristics information for each target location. The characteristics information includes information related to size of the target location and information related to mobility of the terminal. For example, when the location of the terminal 100 is determined to be the inside of the vehicle 5, the terminal 100 detects information regarding maximum distance in the vehicle 5 from its memory.

The terminal 100 may be offered for the tethering for another terminal. The terminal 100 transmits the beacon frame for searching the other terminal to be tethered. The terminal 100 determines, according to the determined characteristics of the determined location, at least one of the transmission power and the scan period for transmitting the beacon frame.

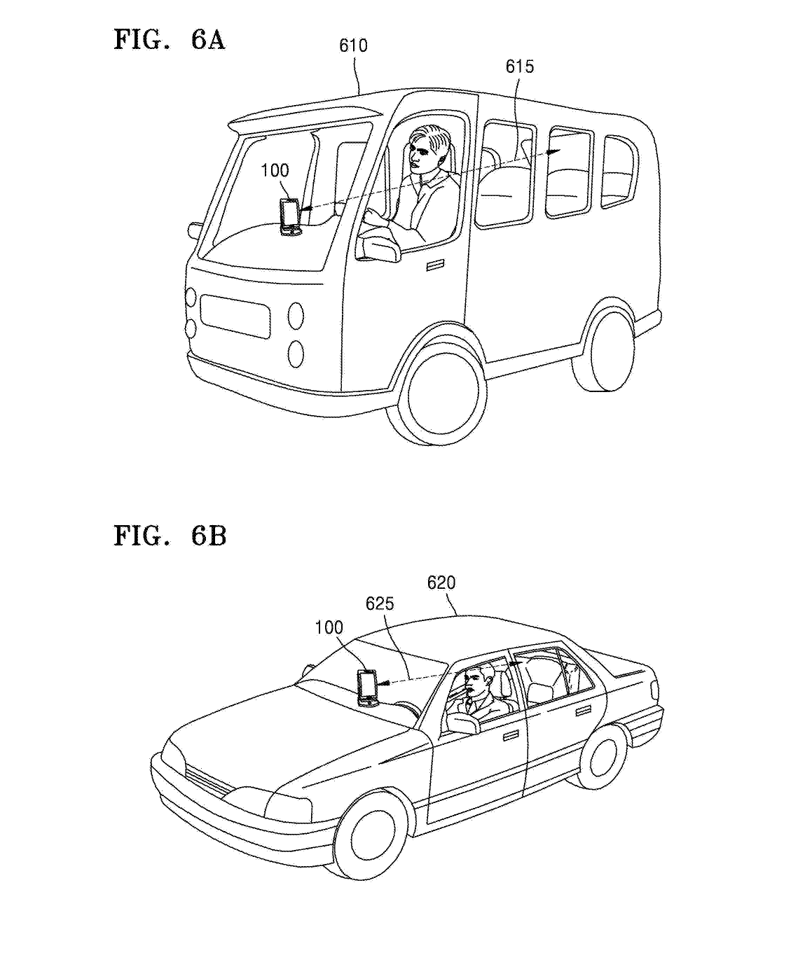

For example, when the terminal 100 is located in the vehicle 5, the terminal 100 increases the scan period or stops the scanning operation. When the terminal 100 is located in the vehicle 5, the terminal 100 decreases the transmission power. The terminal 100 may also change the transmission power depending on type of the vehicle 5, which is described in detail below with reference to FIGS. 6A and 6B.

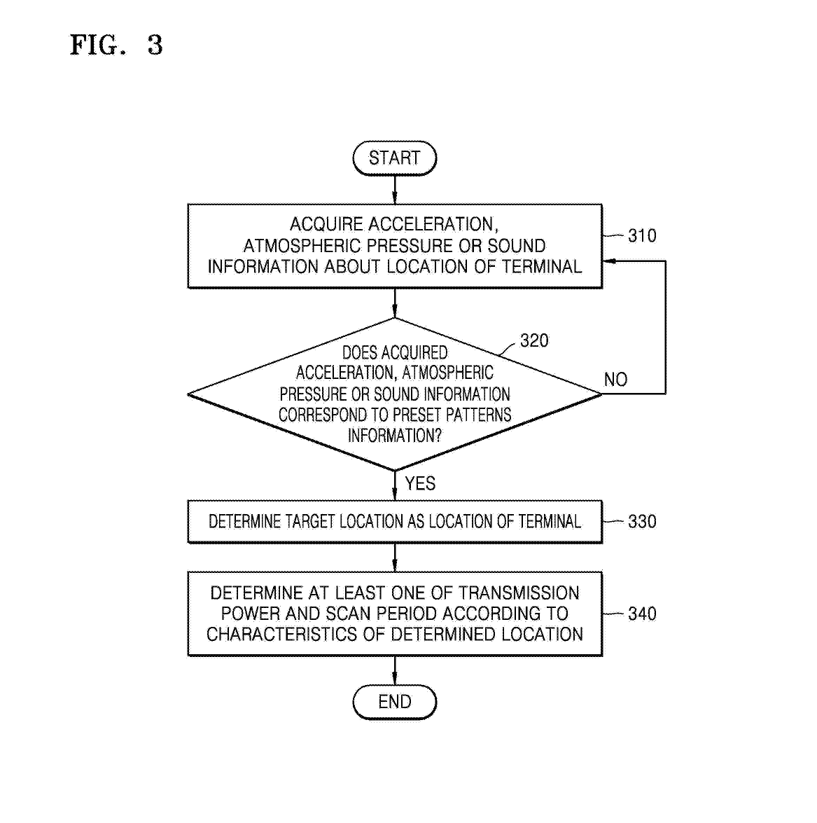

FIG. 3 is a flowchart explaining a method that the terminal 100 determines at least one of the transmission power and the scan period according to characteristics of the terminal location that is determined based on information detected from the surroundings in accordance with an embodiment of the present disclosure.

In step 310, the terminal 100 acquires the context information including at least one of the acceleration information, the atmospheric pressure information, and the sound information that may represent the location of the terminal 100.

The terminal 100 acquires the context information according to a predetermined period. For example, the terminal 100 acquires the acceleration information that represents the motion of the terminal 100 in a predetermined period. Alternatively, the terminal 100 acquires the atmospheric pressure information that represents the atmospheric pressure of the surrounding environment of the terminal 100 in a predetermined period, or acquires the sound information by detecting the sound of the surroundings of the terminal 100 in a predetermined period.

In step S320, the terminal 100 determines whether at least one of the acquired information, such as the acceleration information, the atmospheric pressure information, and the sound information corresponds to the patterns information representing the target location.

The terminal 100 stores the patterns information regarding at least one target location in advance. For example, the terminal 100 stores, in advance, the patterns information representing that the terminal 100 is located inside the vehicle 5.

According to an embodiment, the terminal 100 generates the patterns information based on the context information that the terminal 100 acquired in the target location previously. For example, when the user occupying the terminal 100 is riding in the vehicle 5, the terminal 100 generates the patterns information for the vehicle 5 by using the acceleration information that is determined by changes of velocity of the terminal 100 according to the following Equation (1):

$${P}_{acc} = \sqrt{\frac{{\sum }_{i = 1}^{n} {( {accX}_{i} )}^{2}}{n}} + \sqrt{\frac{{\sum }_{i = 1}^{n} {( {accY}_{i} )}^{2}}{n}} + \sqrt{\frac{{\sum }_{i = 1}^{n} {( {accZ}_{i} - 9.8 )}^{2}}{n}} \qquad ( 1 )$$

In the above equation, Pacc denotes the patterns information determined based on the acceleration information, and accXi, accYi, and accZi denote accelerations in the x-axis, y-axis, and z-axis directions, respectively. Also, n denotes the number of acquisitions of the acceleration information.

According to another embodiment, the terminal 100 generates the patterns information for the vehicle 5 by using the atmospheric pressure information that is changing as the door of the vehicle 5 is closed after the user enters the vehicle 5.

According to yet another embodiment, the terminal 100 measures sound being generated when the door of the vehicle 5 is closed after the user enters the vehicle 5 for example, and generates the patterns information based on measured sound.

According to an embodiment, the terminal 100 determines whether a difference between the patterns information of the target location previously set and at least one of the acquired information, such as the acceleration information, the atmospheric pressure information, and the sound information, is equal to or less than a predetermined threshold. For example, the terminal 100 calculates a context value based on at least one of the acquired information, such as the acceleration information, the atmospheric pressure information, and the sound information, by using an algorithm or rule that is the same as that used in generating the patterns information, and compares the calculated context value with the patterns information to determine whether a difference between the calculated context value and the patterns information is less than or equal to the threshold.

If the difference between the calculated context value and the patterns information is greater than the threshold, the terminal 100 determines that the location of the terminal 100 does not correspond to the target location. If the location of the terminal 100 does not correspond to the target location, the terminal 100 returns to step S310 of acquiring the context information.

If the context information corresponds to the patterns information of the target location, the terminal 100 determines the target location as the location of the terminal 100 in step S330. For example, the terminal 100 determines that the terminal 100 is located in the vehicle 5 as the context information corresponds to the patterns information of the target location.

In step S340, the terminal 100 determines at least one of the transmission power and the scan period, for communications with another terminal, according to the characteristics of determined location.

The terminal 100 may be offered for the tethering for another terminal. The terminal 100 transmits the beacon frame for searching the other terminal to be tethered. The terminal 100 determines, according to the determined characteristics of the determined location, at least one of the transmission power and the scan period for transmitting the beacon frame. For example, the terminal 100 determines the magnitude of the transmission power based on a maximum distance between the terminal 100 and the other terminal. The terminal 100 increases the scan period when the distance between the terminal 100 and the other terminal at the determined location is unlikely to change beyond a predetermined range.

When the terminal 100 is provided with the tethering service by another terminal, the terminal 100 controls the transmission power for transmitting frames to the other terminal depending on the characteristics of the location of the terminal 100.

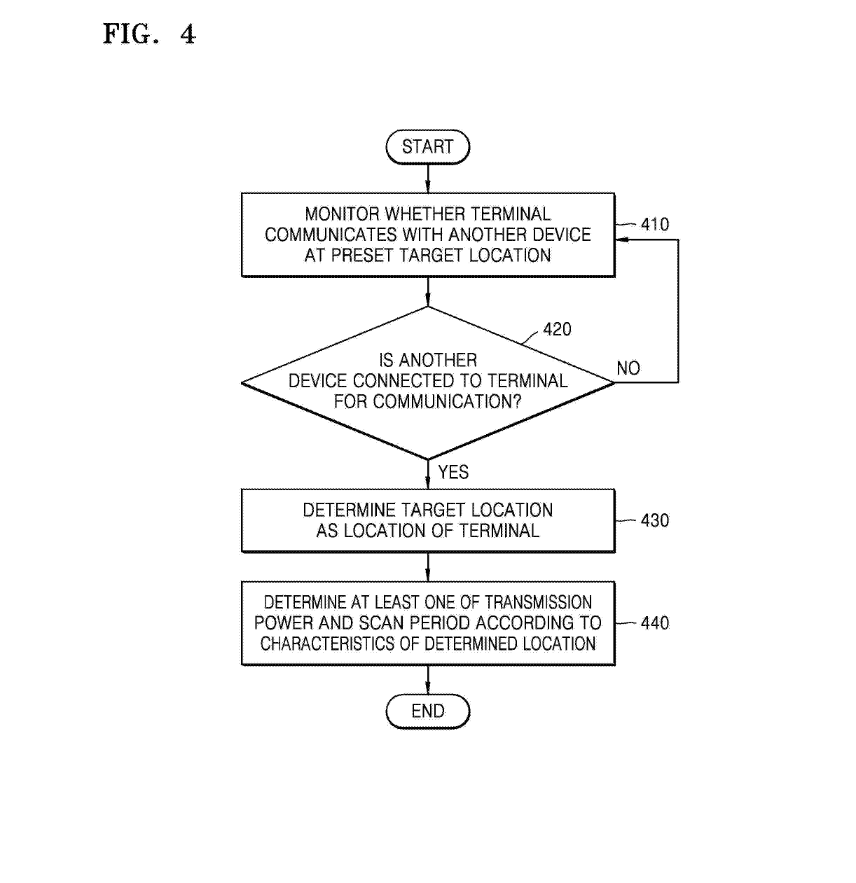

FIG. 4 is a flowchart explaining a method that the terminal 100 determines at least one of the transmission power and the scan period according to characteristics of the terminal location that is determined based on history information of connections between the terminal 100 and another device present at the target location in accordance with an embodiment of the present disclosure.

In step S410, the terminal 100 monitors the connection of the terminal 100 to another device that is present at a target location set previously. For example, the terminal 100 stores in advance, with respect to the vehicle 5, types of information transmitted to or received to and from the wireless charging device or the OBD device when the terminal 100 is connected to the wireless charging device or the OBD device located in the vehicle 5.

The terminal 100 monitors whether the terminal 100 receives power from the wireless charging device located in the vehicle 5. The terminal 100 monitors whether the terminal 100 transmits or receives control signals to or from the OBD device in the vehicle 5 according to a predetermined period.

In step S420, the terminal 100 determines whether another device present at a target location previously set is connected to the terminal 100.

The terminal 100 determines that the other device is connected to the terminal 100 when the other device continuously transmits or receives information to and from the terminal 100. For example, the terminal 100 determines that the terminal 100 is connected to the wireless charging device if thirty (30) seconds has not elapsed since the most recent time of receiving the power from the wireless charging device. The terminal 100 determines that the terminal 100 is not connected to the wireless charging device if more than thirty seconds has elapsed since the most recent time of receiving the power from the wireless charging device.

If it is determined that terminal 100 is not connected to the other device present at the target location, the terminal 100 returns to step S410 for monitoring another device.

If it is determined that the terminal 100 is connected to the other device present at the target location, the terminal 100 determines the target location as the location of the terminal 100 in step S430. For example, if the terminal 100 is determined to be connected to the wireless charging device or the OBD device located in the vehicle 5, the terminal 100 may be determined as being inside the vehicle 5.

In step S440, the terminal 100 determines at least one of the transmission power and the scan period, for communications with another terminal, according to the characteristics of determined location.

The terminal 100 may be offered for the tethering for another terminal. The terminal 100 transmits the beacon frame for searching the other terminal to be tethered. The terminal 100 determines, according to the determined characteristics of the determined location, at least one of the transmission power and the scan period for transmitting the beacon frame. For example, the terminal 100 determines the magnitude of the transmission power based on a maximum distance between the terminal 100 and the other terminal. The terminal 100 increases the scan period when the distance between the terminal 100 and the other terminal at the determined location is unlikely to change beyond a predetermined range.

When the terminal 100 is provided with the tethering service by another terminal, the terminal 100 controls the transmission power for transmitting frames to the other terminal depending on the characteristics of the location of the terminal 100.

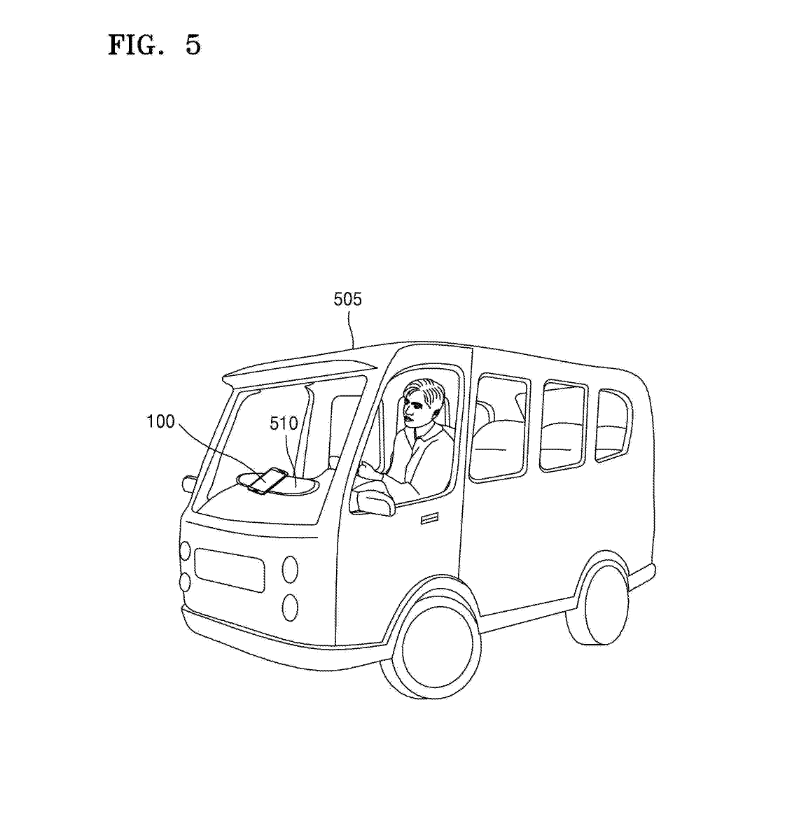

FIG. 5 illustrates a method for determining at least one of the transmission power and the scan period according to characteristics of the terminal location that is determined based on the connection of the terminal 100 and another device 510 present at a target location 505 in accordance with an embodiment of the present disclosure.

Referring to FIG. 5, the terminal 100 is located in the vehicle 505.

The terminal 100 receives power from a wireless charging device 510 along with a frame representing information of the wireless charging device 510. The terminal 100 identifies the wireless charging device 510 by use of an identification value or a manufacturer code of the wireless charging device 510 contained in the frame received from the wireless charging device 510.

The terminal 100 determines that the terminal 100 is located inside the vehicle 505 when the terminal 100 receives power from the wireless charging device 510. For example, the terminal 100 compares an acquired identification value of the wireless charging device 510 with an identification value stored previously for the wireless charging device 510 that is one of devices located inside the vehicle 505.

The terminal 100 determines the magnitude of the transmission power used for the tethering in consideration of a size of the vehicle 505. For example, the terminal 100 determines the magnitude of the transmission power for transmitting a management frame such as a beacon frame used for searching other terminals and the transmission power for broadcasting or unicasting data frames. When the terminal 100 is located in the vehicle 5, the tethering is accomplished in a limited space. In this case, the terminal 100 decreases the magnitude of the transmission power used for transmitting the frames in consideration of the size of the vehicle 505.

When the terminal 100 in the vehicle 505 is provided with the tethering service by another terminal in the vehicle 505, the terminal 100 controls the transmission power for transmitting frames to the other terminal in consideration of the size of the vehicle 505. For example, the terminal 100 controls the transmission power for transmitting the beacon frame and data frames to the other terminal.

Also, when the terminal 100 is located in the vehicle 505, the movable range of the other terminal which uses the tethering service from the terminal 100 may be limited. Thus, the terminal decreases the period for scanning other terminals in the vehicle 505 that may be tethered by the terminal 100.

FIGS. 6A and 6B illustrate a method for determining the transmission power based on types of vehicles 610 and 620 in accordance with an embodiment of the present disclosure.

When the terminal 100 is located in the vehicle 610 or 620, the terminal 100 may be connected to the OBD device installed in the vehicle 610 or 620. As the user occupying the terminal 100 rides in the vehicle 610 or 620, the terminal 100 receives identification information of the vehicle 610 or 620 from the OBD device.

For example, the terminal 100 receives a vehicle identification number (VIN) of the vehicle 610 or 620 from the OBD device. The terminal 100 acquires information indicating that the terminal 100 is located inside of the vehicle 610 or 620 and the information related to the type of the vehicle 610 or 620 by use of the VIN information.

The terminal 100 determines the transmission power required for the terminal 100 to provide the tethering to other terminals in the vehicle 610 or 620 based on size information of the vehicle 610 or 620 that corresponds to the type of the vehicle 610 or 620.

For example, the terminal 100 determines the magnitude of the transmission power based on information indicating that a maximum distance between two points inside the vehicle 610 or 620 is ‘X’. When the transmission power is set to ‘5A’ for tethering devices spaced apart by a distance of ‘5X’ outside the vehicle 610 or 620, the terminal 100 changes the transmission power into a value less than ‘A’ inside the vehicle 610 or 620 in which the maximum distance is ‘X’.

According to another embodiment, when the terminal 100 in the vehicle 610 or 620 is provided with the tethering service by another terminal in the vehicle 610 or 620, the terminal 100 controls the transmission power for transmitting frames to the other terminal in consideration of the size of the vehicle 610 or 620. For example, the terminal 100 controls the transmission power for transmitting the beacon frame and data frames to the other terminal.

Meanwhile, the terminal 100 changes the transmission power according to the type of the vehicle 610 or 620.

Referring to FIG. 6A, when the user occupying the terminal 100 rides in a first vehicle 610, the terminal 100 receives the VIN information of the first vehicle 610 from a first OBD device. The terminal 100 compares received VIN information with VIN information of a plurality of vehicles stored previously in the terminal 100 to determine that the terminal 100 is located inside the first vehicle 610.

The terminal 100 determines the transmission power for providing the tethering service inside the first vehicle 610 by use of the information related to the maximum distance between two points inside the first vehicle 610 stored previously in the terminal 100. It is assumed that the maximum distance inside the first vehicle 610 is ‘2X’. When the transmission power is set to ‘5A’ for tethering devices spaced apart by a distance of ‘5X’ outside the first vehicle 610, the terminal 100 changes the transmission power into a value less than ‘2A’ inside the first vehicle 610 where the maximum distance is ‘2X’.

Referring to FIG. 6B, when the user occupying the terminal 100 rides in a second vehicle 620, the terminal 100 receives the VIN information of the second vehicle 620 from a second OBD device. The terminal 100 compares received VIN information with VIN information of a plurality of vehicles stored previously in the terminal 100 to determine that the terminal 100 is located inside the second vehicle 620.

The terminal 100 determines the transmission power for providing the tethering service inside the second vehicle 620 by use of the information related to the maximum distance between two points inside the second vehicle 620 stored previously in the terminal 100. It is assumed that the maximum distance inside the second vehicle 620 is ‘X’. When the transmission power is set to ‘5A’ for tethering devices spaced apart by a distance of ‘5X’ outside the second vehicle 620, the terminal 100 changes the transmission power into a value less than ‘A’ inside the first vehicle 610 where the maximum distance is ‘X’.

FIGS. 7A and 7B illustrate a method for determining scan periods for other terminals according to characteristics of the location of the terminal 100 in accordance with an embodiment of the present disclosure.

Referring to FIG. 7A, when the terminal 100 is located in open space, the terminal 100 searches other terminals or access points (APs) 710 and 720 based on a predetermined scan period as the user is in motion.

For example, the terminal 100 may be connected to a first access point 710 at a first location but to a second access point 720, at a second location, that is closer than the first access point 710 after the terminal 100 moves to the second location.

If the terminal 100 provides the tethering to other terminals, the terminal 100 may also search other terminals according to a predetermined scan period to update information related to nearby devices as the terminal 100 is in motion.

Referring to FIG. 7B, the terminal 100 may be located inside a vehicle 705. The terminal 100 determines that the terminal 100 is located inside the vehicle 705 by using the acquired context information. The method that the terminal 100 uses to determine whether the terminal 100 is located inside the vehicle 705 by using the acquired context information is the same as the previously-described method.

When the terminal 100 is located in limited space such as inside of the vehicle 705, the terminal 100 decreases the scan period since the other devices located in the neighborhood of the terminal 100 are unlikely to change compared with the case of FIG. 7A.

For example, if the terminal 100 in FIG. 7B provides the tethering to other terminals inside the vehicle 705, the terminal 100 and another terminal 730 are located inside the vehicle 730 while maintaining their distance even when the vehicle 705 is in motion and thus the terminal decreases the scan period.

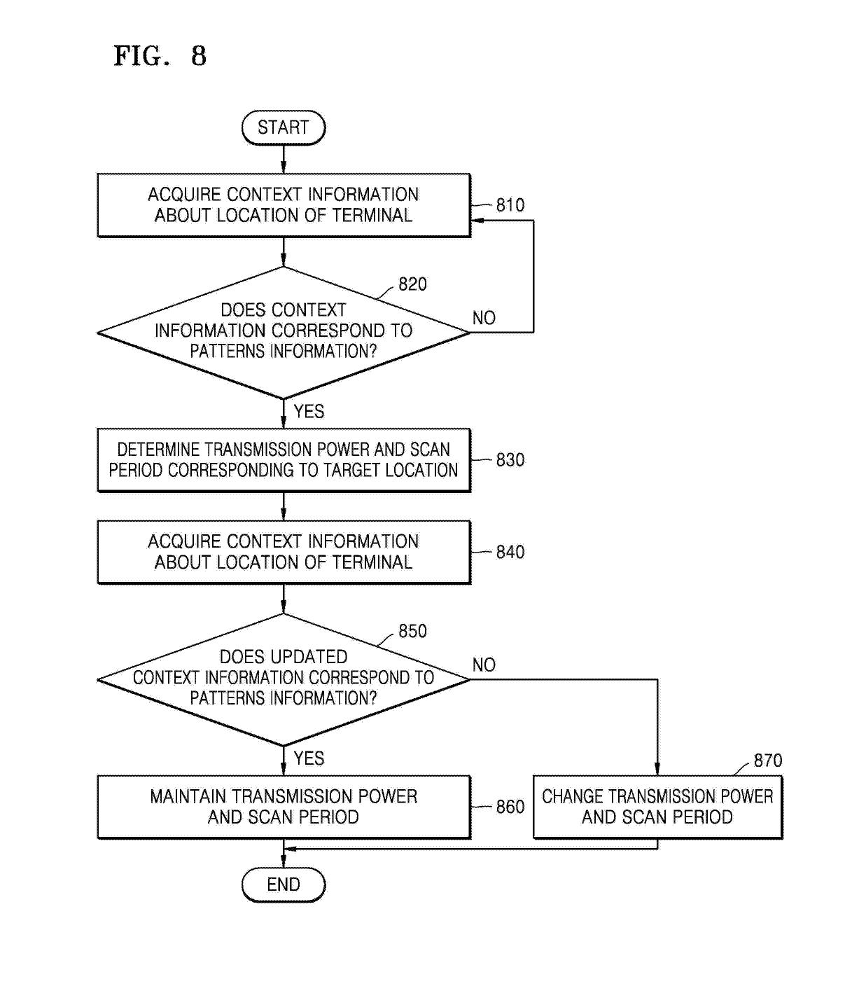

FIG. 8 is a flowchart explaining a method that the terminal 100 acquires the context information in a predetermined interval and updates the information related to the location of the terminal 100 in accordance with an embodiment of the present disclosure.

In step S810, the terminal 100 acquires the context information that represents the location of the terminal 100.

The context information includes the acceleration information of the terminal 100, the atmospheric pressure and sound information of the surroundings. According to another embodiment, the context information includes history information of the connections between the terminal 100 and other terminals in particular location.

In step S820, the terminal 100 compares the acquired context information with patterns information representing the target location set previously. The patterns information may be generated based on the acceleration information, the atmospheric pressure information, the sound information, and the connection history information that may be acquired when the terminal is present at the target location.

If the acquired context information does not correspond to the patterns information of the target location, the terminal returns to step S810 of acquiring the context information.

In step S830, the terminal 100 determines at least one of the transmission power and the scan period, for communications with another terminal, according to the characteristics of determined location.

The terminal 100 stores characteristics information for each target location. The characteristics information includes information related to size of the target location and mobility of the terminal.

The terminal 100 may be offered for the tethering for another terminal. The terminal 100 transmits the beacon frame for searching the other terminal to be tethered. The terminal 100 determines, according to the determined characteristics of the determined location, at least one of the transmission power and the scan period for transmitting the beacon frame.

According to another embodiment, when the terminal 100 in the vehicle 5 is provided with the tethering service by another terminal in the vehicle 5, the terminal 100 controls the transmission power for transmitting frames to the other terminal in consideration of the size of the vehicle 5.

In step S840, the terminal 100 acquires the context information representing the location of the terminal 100. In step S850, the terminal 100 compares newly acquired context information with patterns information representing target location determined previously. According to an embodiment, the terminal 100 compares the context information updated in step S840 with patterns information representing target location determined based on the context information acquired previously.

In step S860, if the updated context information corresponds to the patterns information representing the target location determined based on the context information acquired previously, the terminal 100 maintains the transmission power and the scan period.

In step S870, if the updated context information does not correspond to the patterns information representing the target location determined based on the context information acquired previously, the terminal 100 changes the transmission power and the scan period according to characteristics of a location newly determined based on the updated context information.

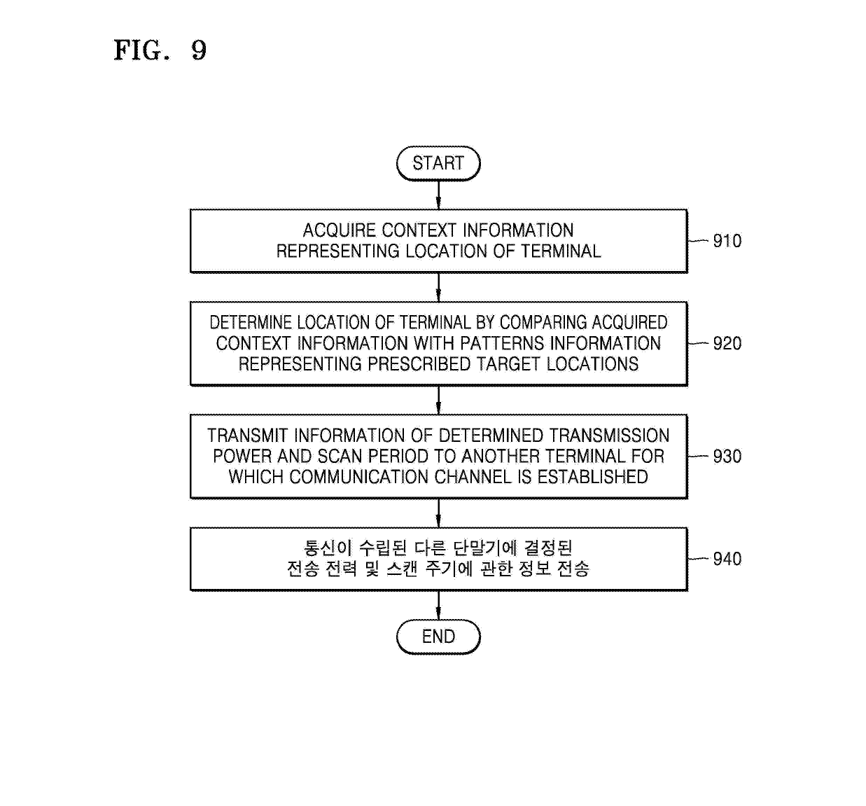

FIG. 9 is a flowchart explaining a method that the terminal 100 transmits information of at least one of the transmission power and the scan period to another terminal present at a target location when the terminal 100 is located at the target location, according to an embodiment of the present disclosure.

In step S910, the terminal 100 acquires the context information that represents the location of the terminal 100.

The context information includes the acceleration information of the terminal 100, the atmospheric pressure and sound information of the surroundings. According to another embodiment, the context information includes history information of the connections between the terminal 100 and other terminals in particular location. In step S920, the terminal 100 determines the location of the terminal 100 by comparing the acquired context information with patterns information representing the target location set previously. The patterns information may be generated based on the acceleration information, the atmospheric pressure information, the sound information, and the connection history information that may be acquired when the terminal is present at the target location.

In step S930, the terminal 100 determines at least one of the transmission power and the scan period, for communications with another terminal, according to the characteristics of determined location. In step S940, the terminal 100 transmits information related to at least one of the transmission power and the scan period determined in step S930 to the other terminal to which a communications channel is being established.

The terminal 100 establishes a communications channel to the other terminal present at the target location, such as by broadcasting or unicasting the beacon frame according to the transmission power and the scan period determined as in step S930.

The other terminal for which the communications channel is established to the terminal 100 receives the information related to at least one of the transmission power and the scan period from the terminal 100, and changes the transmission power or the scan period corresponding to the target location without any need for separately acquiring the context information and determining its location.

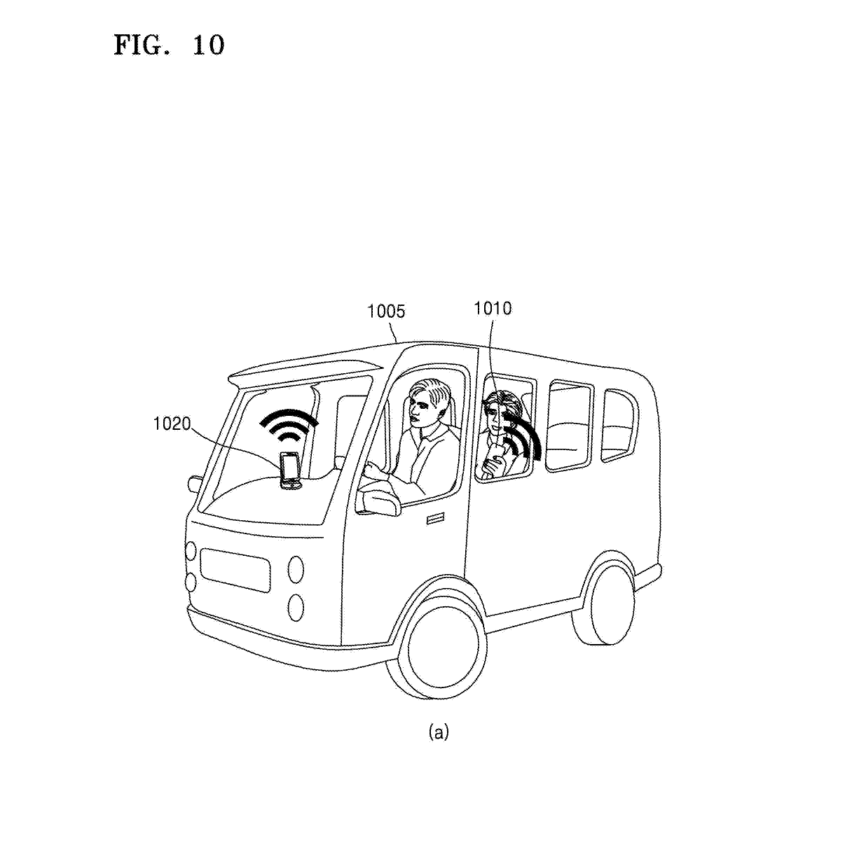

FIG. 10 illustrates a method that a terminal 1010 transmits information of at least one of the transmission power and the scan period to another terminal 1020 present at a target location when the terminal 1010 is located at the target location, according to an embodiment of the present disclosure.

The terminal 1010 acquires context information representing the location of the terminal 1010. For example, the terminal 1010 acquires at least one of: atmospheric pressure and the sound information of the surroundings. According to another embodiment, the terminal 1010 acquires history information of the terminal 100 about connections with other terminals present at a particular location.

The terminal 1010 determines the location of the terminal 1010 by comparing acquired context information with patterns information representing a vehicle 1005. For example, the terminal 1010 acquires information related to the maximum distance inside the vehicle 1050 or mobility of the terminal by comparing the acquired context information with the patterns information.

The terminal 1010 increases the scan period when the terminal 1010 is located in limited space of the vehicle 1005. The terminal 1010 determines the magnitude of the transmission power used for the tethering in consideration of the maximum distance inside the vehicle 1005.

The terminal 1010 establishes a communications channel with another terminal 1020 present inside the vehicle 1005 according to the transmission power and the scan period determined as previously described. When the communications channel is established between the terminal 1010 and the other terminal 1020, the terminal 1010 transmits the information related to the transmission power and the scan period to the other terminal 1020.

The other terminal 1020 for which the communications channel is established to the terminal 1010 receives the information related to the transmission power and the scan period from the terminal 1010, and changes the transmission power or the scan period corresponding to the target location without any need for separately acquiring the context information and determining its location.

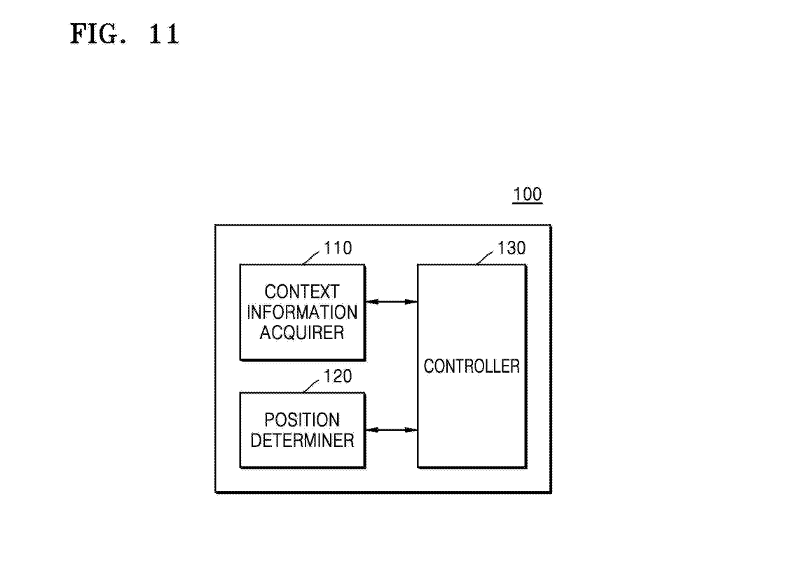

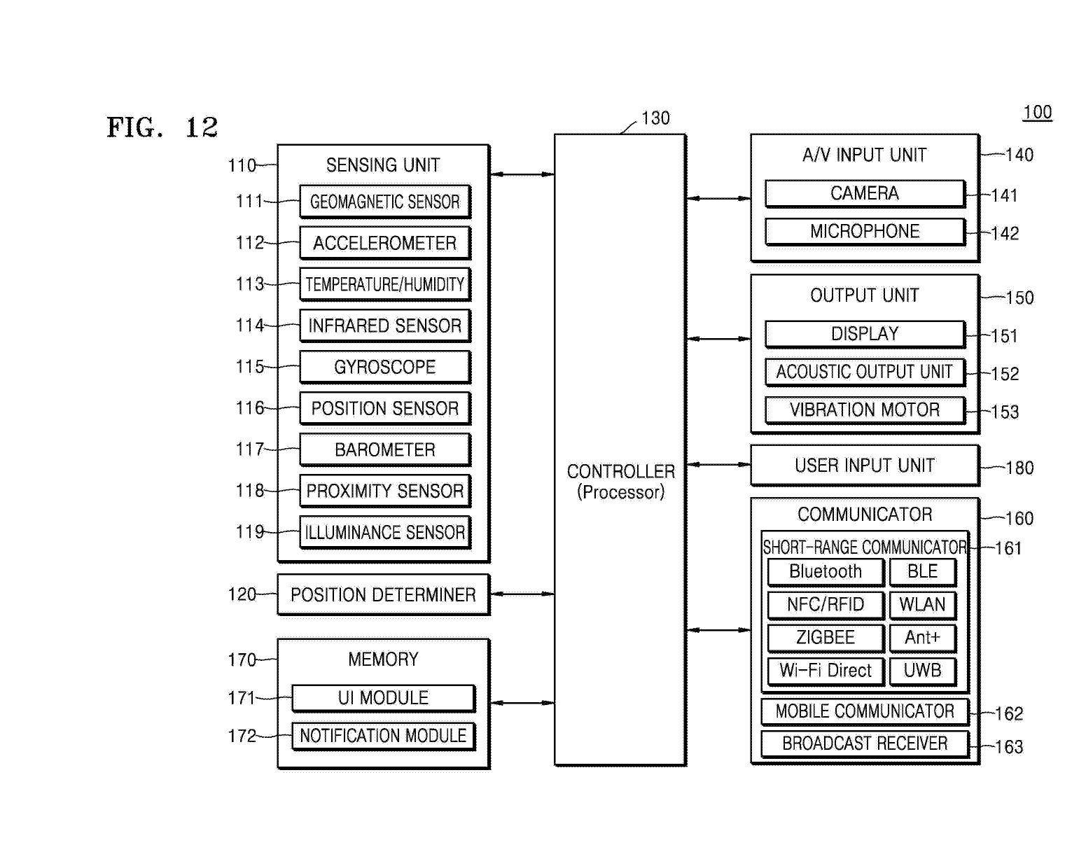

FIGS. 11 and 12 are block diagrams of the terminal 100 according to an embodiment of the present disclosure.

As shown in FIG. 11, the terminal 100 includes a context information acquirer 110, a position determiner 120, and a controller 130. However, it should be noted that not all the elements shown in the drawings are essential, and the terminal 100 may be implemented to include additional or fewer elements than those illustrated.

For example, as shown in FIG. 11, the terminal 100 includes an audio/video (AN) input unit 140, an output unit 150, a communicator 160, and a memory 170 in addition to the context information acquirer 110, the position determiner 120, and the controller 130.

The configuration of the terminal 100 will now be described in detail.

The context information acquirer 110 acquires the context information representing the location of the terminal 100. The context information includes the acceleration information of the terminal 100, the atmospheric pressure and sound information of the surroundings. According to another embodiment, the context information includes history information of the connections between the terminal 100 and other terminals present at particular locations. The context information acquirer 110 acquires the connection history information by monitoring connections of the terminal 100 with the other terminals present at the particular locations.

The context information acquirer 110 may be a sensing unit which includes at least one of: a geomagnetic sensor 111, an accelerometer 112, a temperature and humidity sensor 113, an infrared sensor 114, a gyroscopic sensor 115, a position sensor 116 such as a GPS signal receiver, a barometer 117, a proximity sensor 118, an illuminance sensor 119.

The context information acquirer 110 receives, from an A/V input unit 140 described below, the sound information representing sound being generated in the surroundings of the terminal 100 and acquired by the A/V input unit 140.

The position determiner 120 determines the location of the terminal 100 by comparing the acquired context information with patterns information representing the target location previously set. The patterns information may be generated based on the acceleration information, the atmospheric pressure information, the sound information, and the connection history information that may be acquired when the terminal is present at the target location.

The position determiner 120 determines whether at least one of the acquired information, such as the acceleration information, the atmospheric pressure information, and the sound information corresponds to the patterns information representing the target location. If the acquired information corresponds to the patterns information of the target location, the position determiner 120 determines the target location as the location of the terminal 100. For example, the position determiner 120 determines whether a difference between the patterns information of the target location previously set and at least one of the acquired information, such as the acceleration information, the atmospheric pressure information, and the sound information, is equal to or less than the predetermined threshold. The position determiner 120 calculates a context value based on at least one of the acquired information, such as the acceleration information, the atmospheric pressure information, and the sound information, by using an algorithm or rule that is the same as that used in generating the patterns information, and compares the calculated context value with the patterns information to determine whether a difference between the calculated context value and the patterns information is equal to or less than the threshold.

The position determiner 120 determines whether another device present at a target location previously set is connected to the terminal 100. According to an embodiment, the position determiner 120 determines that the other device is connected to the terminal 100 when the other device continuously transmits or receives information to and from the communicator 160 of the terminal 100.

The position determiner 120 determines the type of the vehicle 5 also by use of the context information when the location of the terminal 100 is inside the vehicle 5.

The controller 130 generally controls overall operation of the terminal 100, such as the sensing unit 110, the AN input unit 140, the output unit 150, the communicator 160, the memory 170, and the user input unit 180 by executing programs stored in the memory 170.

The controller 130 generates the patterns information based on the context information indicating that the terminal 100 acquired in the target location. For example, when the user occupying the terminal 100 is riding in the vehicle 5, the controller 130 generates the patterns information representing the vehicle 5 based on the acceleration information indicating that is determined by changes of velocity of the terminal 100

According to another embodiment, the controller 130 generates the patterns information for the vehicle 5 by using the atmospheric pressure information that is changing as the door of the vehicle 5 is closed after the user enters the vehicle 5.

According to another embodiment, the controller 130 measures sound being generated when the door of the vehicle 5 is closed after the user enters the vehicle 5 for example, and generates the patterns information based on measured sound. The controller 130 generates the patterns information of the vehicle 5 using the connection history information that represents exchange of information between the terminal 100 and the other device present inside the vehicle 5.

The controller 130 determines at least one of the transmission power and the scan period, for communications of the terminal 100 with another terminal, according to the characteristics of the location of the terminal 100 determined by the position determiner 120.

For example, the controller 130 determines the magnitude of the transmission power based on a maximum distance between the terminal 100 and the other terminal. The controller 130 increases the scan period when the distance between the terminal 100 and the other terminal at the determined location is unlikely to change beyond a predetermined range.

That is, when the terminal 100 is located inside the vehicle 5, the controller 130 decreases the transmission power compared with a situation when the terminal 100 is located outside the vehicle 5. When the terminal 100 is located inside the vehicle 5, the controller 130 increases the scan period compared with a situation when the terminal 100 is located outside the vehicle 5. The controller 130 may stop searching additional terminals when a communications channel is established between the terminal 100 and the other terminal in the vehicle 5.

When the type of the vehicle 5 in which the terminal 100 is located was determined based on the context information, the controller 130 changes the transmission power based on an internal distance of the vehicle 5 which is identifiable from the type of the vehicle 5.

According to another embodiment, when the terminal 100 is provided with the tethering service by another terminal, the controller 130 controls the transmission power for transmitting frames to the other terminal depending on the characteristics of the location of the terminal 100.

The A/V input unit 140 receives audio signals or video signals and includes a camera 141 and a microphone 142. The camera 141 acquires still images or video frames of a moving picture through an image sensor in a video call mode or a photograph mode. The images captured through the image sensor may be processed by the controller 130 or a separate image processor.

The video frames processed by the camera 141 are stored in the memory 170 or transmitted externally through the communicator 160. The camera 141 may be provided in plural form depending on the implementation.

The microphone 142 receives external sounds and transforms the sound into electric sound signals. For example, the microphone 142 receives the sound from an external device or a caller.

For instance, the microphone 142 receives various sounds such as the sound of opening or slamming a door when the user occupying the terminal 100 rides in the vehicle 5 and the sound of sitting on a seat of the vehicle 5.

The microphone 142 utilizes various noise reduction algorithms to reduce noises introduced during the input of the external sounds.

The output unit 150 includes a display 151, an acoustic output unit 152, and a vibration motor 153.

The display 151. outputs information processed by the terminal 100. When the display 151 is implemented as a touch screen where a display panel and a touch pad compose a layer structure, the display 151 may be used as an output device as well as an input device. The display 151 includes at least one of: a liquid crystal display (LCD), a thin film transistor-liquid crystal display (TFT-LCD), an organic light-emitting diode (OLED) display, a flexible display, a three dimensional (3D) display, and an electrophoretic display. The terminal 100 includes two or more displays 151 depending on the implementation. The displays 151 may be disposed to face each other by use of a hinge.

The acoustic output unit 152 outputs audio data received from the communicator 160 or stored in a memory 170, and outputs acoustic sounds related with operations performed by the terminal 100 such as ringtones, message ringtones, and notification sounds. The acoustic output unit 152 includes a speaker and a buzzer.

The vibration motor 153 generates vibrations. For example, the vibration motor 153 outputs vibrations corresponding to video outputs or audio outputs such as the ringtone and the message ringtone, and outputs vibrations when a touch input is applied to a touch screen.

The communicator 160 transmits information related to at least one of the transmission power and the scan period determined by the controller 130 to the other terminal. The communicator 160 facilitates communications between the terminal 100 and the other device present at the target location.

The communicator 160 includes at least one element for enabling communications between the terminal 100 and at least one other device or between the terminal 100 and another terminal. For example, the communicator 160 includes a short-range wireless communicator 161, a mobile communicator 162, and a broadcast receiver 163.

The short-range wireless communicator 161 includes, but is not limited to, a Bluetooth™ communicator, a Bluetooth low energy (BLE) communicator, a wireless LAN communicator, a near field communication (NFC) unit, an Ant+ communicator, a ZigBee communicator, an infrared data association (IrDA) communicator, a WiFi communicator, WiFi-direct (WFD) communicator, and an ultra-wideband (UWB) communicator.

The mobile communicator 162 transmits and receives wireless signals to and from at least one of a base station of a mobile communications network, an external terminal, and a server. The wireless signals include various kinds of data related with transmission and receipt of voice call signals, video call signals, text messages, or multimedia messages.

The broadcast receiver 163 receives broadcast signals and/or broadcast related information through broadcast channels. The broadcast channels include satellite broadcast channels and terrestrial broadcast channels. The broadcast receiver 163 may not be included in the terminal 100 depending on the implementation of the terminal 100.

The memory 170 stores programs for processing and control operations of the controller 130 and data input to the terminal 100 or output from the terminal 100, such as a plurality of menus, a first hierarchical sub-menu corresponding to respective one of the plurality of menu, and a second hierarchical sub-menu corresponding to respective one of the first hierarchical sub-menus.

The memory 170 stores patterns information that represents target locations generated by the controller 130. For example, the memory 170 stores patterns information that represents the vehicle 5, and stores patterns information for each type of the vehicle 5 and characteristics information for each type of the vehicle 5. The characteristics information includes information of the maximum distance in the vehicle 5.

The memory 170 includes at least one of a flash memory, a hard disk, a multimedia card micro, a card-type memory such as a SD or XD memory, a random access memory (RAM), a read-only memory (ROM), an electrically erasable and programmable read-only memory (EEPROM), a programmable read-only memory (PROM), a magnetic memory, a magnetic disc, and an optical disk. The terminal 100 may operate a web storage or a cloud server that performs storing function of the memory 170 on the Internet.

The programs stored in the memory 170 may be categorized into a plurality of modules, according to their functions, such as a user interface (UI) module 171, a touch screen module 172, and a notification module 173.

The UI module 171 provides a user interface or graphic user interface that is specialized for each application and interacts with the terminal 100. The touch screen module 172 senses touch gestures on a touch screen of the user, and may transfer the touch gesture information to the controller 130. The touch screen module 172 according to some embodiments may recognize and analyze touch codes. The touch screen module 172 may be configured as a separate hardware including the controller.

Various sensors may be provided in or near the touch screen to sense a touch or a hovering of the touch screen. One example of the sensor for sensing the touch of the touch screen is a tactile sensor. The tactile sensor detects the stimulus of a contact on a specific object in a human sensitivity or a higher sensitivity, and detects various information such as the roughness of a touched surface, the hardness of a touching body, and the temperature of a touched position.

Another example of the sensor for sensing the touch of the touch screen is a proximity sensor, which detects the presence of an object approaching a predetermined detection surface or a nearby object by use of electromagnetic field intensity or infrared ray without any physical contact. Examples of the proximity sensor include a through-beam photoelectric sensor, a diffuse-reflective photoelectric sensor, a retro-reflective photoelectric sensor, a high frequency oscillation proximity sensor, a capacitance proximity sensor, a magnetic proximity sensor, and an infrared proximity sensor. The touch gestures of the user may include ‘tap’, ‘double tap’, ‘to touch and hold’, ‘to drag item’, ‘to slide finger’, ‘to flick finger’, ‘to drag and drop item’, and ‘to swipe’.

The notification module 173 generates a signal for notifying an event occurred in the terminal 100, such as receiving a call, receiving a message, a key input entry, and a schedule notification. The notification module 173 outputs notifications in a video form through the display 151, in an audio form through the acoustic output unit 152, or in vibrations through the vibration motor 153.

The user input unit 180 may be used to receive user input for controlling the terminal 100. Examples of the user input unit 180 include, but are not limited to, a keypad, a dome switch, a touchpad, a jog wheel, and a jog switch. In particular, the touchpad may be one of various types including capacitive overlay, resistive overlay, infrared beam, surface acoustic wave, integral strain gauge, and piezoelectric types.

The methods according to embodiments of the present disclosure may be implemented as computer instructions which can be executed by various computer means, and recorded on a non-transitory computer-readable medium. The computer-readable medium may include program commands, data files, data structures or a combination thereof. Program instructions recorded on the medium may be particularly designed and structured for the inventive concept or available to those skilled in computer software.

Examples of a non-transitory computer-readable recording medium include magnetic media such as a hard disk, a floppy disk, and a magnetic tape, optical media such as compact disk-read only memory (CD-ROM) and a digital versatile disc (DVD), magneto-optical media such as a floptical disk, a read-only memory (ROM), random access memory (RAM), and flash memory. The medium may be a transmission medium, such as an optical or metal line, a waveguide, or carrier waves transferring program commands, data structures, and the like.

Program commands may include, for example, a high-level language code that can be executed by a computer using a compiler or an interpreter, as well as a machine language code generated by a compiler.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A method of controlling a terminal, the method comprising:
acquiring context information related to a location of the terminal;
determining the location of the terminal by comparing acquired context information and patterns information related to a target location previously set; and
determining at least one of transmission power and a scan period for communication between the terminal and another terminal according to characteristics of the determined location.

2. The method of claim 1, wherein the target location previously set is inside a vehicle, and
wherein determining the location of the terminal comprises determining a type of the vehicle based on the context information.

3. The method of claim 2, wherein determining at least one of the transmission power and the scan period comprises:
decreasing the transmission power, by the terminal, when the terminal is located inside the vehicle, the transmission power and increasing the scan period, by the terminal, when the terminal is located outside the vehicle.

4. The method of claim 2, wherein determining at least one of the transmission power and the scan period comprises:
stopping a scan operation of searching for another terminal when a communication channel is established between the other terminal and the terminal, and the other terminal and the terminal are inside the vehicle.

5. The method of claim 2, wherein determining at least one of the transmission power and the scan period comprises:
changing a magnitude of the transmission power based on an internal distance of the vehicle, where the internal distance depends on the determined type of the vehicle.

6. The method of claim 1, wherein the location of the terminal is determined based on whether the terminal communicates with the other terminal present at the target location previously set, and
wherein the other device transmits power to the terminal.

7. The method of claim 1, further comprising:
generating the patterns information based on previous context information that the terminal previously acquired at the previously set target location.

8. The method of claim 1, further comprising:
transmitting, to the other terminal, information related to a determined one of the transmission power and the scan period.

9. The method of claim 1, further comprising:
changing the transmission power and the scan period when the location of the terminal determined based on acquired context information in a predetermined period changes.

10. A terminal comprising:
a context information acquirer that acquires context information related to a location of the terminal;
a position determiner that determines the location of the terminal by comparing acquired context information and patterns information related to a target location previously set; and
a controller that determines at least one of transmission power and a scan period for communication between the terminal and another terminal according to characteristics of the determined location.

11. The terminal of claim 10, wherein the target location previously set is inside a vehicle, and
wherein the position determiner further determines a type of the vehicle based on the context information.

12. The terminal of claim 11, wherein, when the terminal is located inside the vehicle, the controller further decreases the transmission power and increases the scan period, in comparison to when the terminal is located outside the vehicle.

13. The terminal of claim 11, wherein, when a communication channel is established between the other terminal and the terminal, and the other terminal and the terminal are both inside the vehicle, the controller further stops a scan operation of searching for another terminal.

14. The terminal of claim 11, wherein the controller further changes a magnitude of the transmission power based on an internal distance of the vehicle, where the internal distance depends on the determined type of the vehicle.

15. The terminal of claim 10, wherein the position determiner further determines the location of the terminal based on whether the terminal communicates with the other terminal at the target location previously set, and
wherein the other device transmits power to the terminal.

16. The terminal of claim 10, wherein the controller further generates the patterns information based on previous context information that the terminal previously acquired at the previously set target location.

17. The terminal of claim 10, further comprising:
a communicator that transmits, to the other terminal, information related to a determined one of the transmission power and the scan period.

18. The terminal of claim 10, wherein the controller further changes the transmission power and the scan period when the location of the terminal determined based on acquired context information in a predetermined period changes.

19. A non-transitory computer-readable storage medium having stored therein program instructions which, when executed by a computer, perform a method of controlling a terminal, the method comprising:
acquiring context information related to a location of the terminal;
determining the location of the terminal by comparing acquired context information and patterns information related to a target location previously set; and
determining at least one of transmission power and a scan period for communication between the terminal and another terminal according to characteristics of the determined location.
